(19) United States
(12) Patent Application Publication
(10) Pub. No.: US 2008/0181996 A1
(43) Pub. Date: Jul. 31, 2008

(54) Marker grill

(76) Inventor: Cecil Yother, Alameda, CA (US)

Correspondence Address: QUINE INTELLECTUAL PROPERTY LAW GROUP, P.C., P O BOX 458, ALAMEDA, CA, 94501, US

(21) Appl. No.: 11/506,194

(22) Filed: Aug. 16, 2006

Related U.S. Application Data
(60) Provisional application No. 60/709,625, filed on Aug. 18, 2005.

(51) Int. Cl. A22C 17/10; A47J 37/06; A47J 37/00

(52) U.S. Cl. 426/383; 126/25 R; 99/352

(57) ABSTRACT

This invention provides devices and methods using grills that include perforated surfaces presenting mirror image indicia letter or design components that can be seared onto food as it is cooked.

### CROSS-REFERENCE TO RELATED APPLICATIONS

This application claims priority to and benefit of a prior U.S. Provisional Application No. 60/709,625, Marker Grill, by Cecil Yother, Jr., filed Aug. 18, 2005. The full disclosure of the prior application is incorporated herein by reference.

### FIELD OF THE INVENTION

The invention is in the field of devices and methods for searing indicia onto food. A perforated cooking grill with mirror image indicia is heated to both cook the food and sear the indicia onto the food.

### BACKGROUND OF THE INVENTION

The idea of searing indicia onto food may be considered to date back to the branding of livestock or incidental grill marking of steaks at a barbeque. Cowboys in the American West were known to heat a branding iron in a fire, then sear a permanent scar mark “brand” on the hide of a living horse or cow. The branding iron consisted of a long handle attached to a working end mirror image wrought iron symbol that was heated in the fire. Later, when the cow is cooked, the meat may obtain grill marks from ranks of parallel thick wire supports on the familiar barbeque grill. People have associated these grill marks with the good times and smoky flavor of out door grilling.

Several technologies exist providing machinery to impress real or artificial grill marks on food. These are basically industrial conveyor systems that leave fake grill marks, without actually cooking the food, as either the food or grill moves down a production line. For example, in Naivar, U.S. Pat. No. 5,992,305, Diamond-Shaped Charmaker, as burger patties move down a conveyer they pass in contact under hot rollers that leave linear grill marks on the patty upper surface. A similar hot branding occurs when patties move through upper and lower hot rollers in Linfore, et al., U.S. Application 2001/0043974, Method and Apparatus for Making Flame-Grilled Patties. These inventions grill mark patties are on a scale not useable at home, do not provide interesting marks, and do not actually cook the food.

Somewhat more interesting marks are made on food in Method for Preparing Indicia-Containing Article, U.S. Pat. No. 5,085,890, to Niaura et al. Corporate logos, or fake grill marks, are dried onto a cellulose casing then transferred to the surface of a food product in a manner not too different from offset printing. The food is not actually seared or cooked. This technology is similar to carcass marking technology of Williams, in U.S. Pat. No. 2,083,765. These are industrial scale technologies that fail to either sear or cook the food. They are merely ways to apply labels to the surface of food.

In Method of Marking Meats, U.S. Pat. No. 605,120, to Nathan, raw meat, such as pork bellies, is placed on a grill for smoking. The wire grill includes mirror image trademarks or letters that will appear on the meat as a negative image. That is, the smoke rises to contact and darken portions of the meat not covered by the grill wires, thus leaving lighter areas where the meat rests on the grill. As the meat is dehydrated in the smoking process, the meat receives embedded grooves where it rests on the grill wires. Nathan finds hot branding of meat to be undesirable because he says it works poorly on irregular meat surfaces, and injures or destroys the meat. Nathan specifically does not sear or cook the meat

In view of the above, a need exists for a convenient way to grill or cook food, leaving interesting indicia on the surface. It would be desirable to have food cooked with desired indicia at an actual barbeque for the fun and flavor, e.g., in a private person's back yard. Informative indicia grilled onto food cooked for immediate consumption could provide appealing and interesting advertising directed to backyard barbeque enthusiasts. The present invention provides these and other features that will be apparent upon review of the following.

### SUMMARY OF THE INVENTION

The methods and cooking devices include grilling surfaces that impart images to food while it is being cooked. As compared to inventions old in the art, the present invention, e.g., can both cook and mark the food on the grill, can include grills without wires on the cooking surface, can have both the food and grill remain stationery during the cooking, can cook the food with the food on top of the grill, and/or can employ mirror image letters or non-linear designs. The present inventions provide unique combinations of features, e.g., practical for use by private chiefs in their homes and yards.

A device of the invention for cooking and marking food can include, e.g., a grill with a perforated cooking surface having mirror image alphanumeric character components and/or nonlinear design components. The grill surface character and design components searing surfaces are typically continuous with the cooking surface and not offset up or down from the general cooking surface. The grill and food can be heated by a heat source functionally positioned to transfer heat to the grill, so that the food on the grill is cooked and receives a sear mark from contact with the character or design component.

In particular embodiments, the device for marking food does not have wires contacting the food at the cooking surface. For example, the device can include a grill substantially formed from a sheet of heat resistant material and comprising a perforated cooking surface with mirror image alphanumeric characters and/or nonlinear design components. The grill can be heated by a heat source to sear a mark at sharply delineated points where the food contacts character or design components.

Whereas much of the old marking devices in the art employ such complex components as heated rolling drums and conveyor belts, many components of the present invention can remain at rest. For example, the device can include a stationary grill with a perforated cooking surface having a cooking surface with mirror image alphanumeric characters or nonlinear design components. The grill can be heated by a heat source, and food placed at rest on the grill can receive a sear mark from contact with the character or design component. Such devices can be less expensive and smaller, making them more suitable for the mass market.

In a preferred embodiment, the characters or designs on the cooking surface are relatively small and repeated in a matrixed pattern. Smaller repeated designs can have the advantage that food can be placed randomly, or at various different locations, and still be guaranteed a complete and legible sear mark on the surface. For example, the device for marking food can include a grill with a perforated cooking surface having mirror image alphanumeric character components and/or nonlinear design components arranged in a pattern repeating in a two dimensional repeating matrix (e.g., in rows and columns or diagonals). Again a heat source can be functionally positioned to transfer heat to the grill so that food placed on the grill receives a sear mark from contact with the character or design components.

Much of the old grill marking devices contacted the food from above. Certain embodiments of the present invention have the advantage of grill placement below the food. With the food on top of the grill, heat can be transferred more efficiently to cook or sear the food. Cooking from below can force juices up in the food where they are more likely to be retained than if they are forced to drip out the bottom of the food. In many methods of the invention, a grill comprising a perforated cooking surface with mirror image alphanumeric character or nonlinear design components is heated. Food is placed on top of the grill to be cooked and receives a sear mark from contact with the character or design component. Such a method can make it convenient for chiefs to handle and turn the food during the cooking process.

In some embodiments of the invention, the sear marks do not directly provide the letter or design component indicia, but form an outline around the indicia. In such cases, the indicia can appear as negative images or lighter areas surrounded by a seared border. For example, a device for cooking and marking food can include a grill with the perforations in the cooking surface representing mirror image alphanumeric character components or nonlinear design components. A heat source is functionally positioned to transfer heat to the grill. When food is placed on the grill, it is cooked and receives sear marks that outline the character or design component on the surface of the food.

In a preferred specific embodiments, the grill marking devices of the invention include favored combinations of design features. In one such embodiment, a device for cooking and marking food includes a grill with a substantially horizontal perforated metal plate cooking surface and the surface or the perforations present mirror image alphanumeric character components or nonlinear design components. In preferred embodiments the character or design components comprise cooking surfaces in substantially the same plane as the cooking surface generally, e.g., to aid in food manipulations using a spatula. Food for marking is meat or vegetables and rests on top of the cooking surface character or design components. The heat source is a charcoal or propane flame beneath the grill and functionally positioned to transfer heat to the grill. The food is cooked and receives a sear mark from contact with the cooking surface, thus grill marking or outlining the character or design component on the surface of the food.

Grills of the devices and methods are perforated to form indicia. There are many optional aspects of the grills. The grills can be made from, e.g., a metal, stainless steel, chromed steel, nickel plated steel, ceramic, and/or the like. The grills can have a round peripheral edge. The grills can be stationary during contact with the food and have a surface substantially free of wires. Grills, as is understood in the art, are unitary perforated cooking platforms. In preferred embodiments, a indicia appliqué removably mounted to a grill is not considered to be a “grill”, as is understood in the art.

Heat sources can include, e.g., burning charcoal, propane flame, solar heat, hot fluids, a natural gas flame, electrical resistive heating elements, a wood fire, and/or the like. The heat source can be positioned above, below, and/or within the grill.

Cooking food can include, e.g., heating it until it is no longer considered to be raw, or is considered to be at least cooked “rare”, as is known in the art. Cooking can include heating the food throughout to at least 130° F. Whereas searing can occur instantaneously when food contacts a hot grill, cooking a substantial piece of food can take 5 minutes or more in contact with the grill and/or heat source to reach adequate temperatures internal to the surface to be considered cooked.

Any food desirable to cook and sear can benefit from the invention. For example, the food can be meat, hamburger patties, veggie burgers, vegetables, hot dogs, bread, cheese, fish, and/or the like can be cooked and seared using cooking devices of the invention.

The sear marks can be essentially any writing characters or non-linear designs. The sear mark can be, e.g., a logo, a trade mark, an acronym, two or more different alphanumeric characters, initials of a person, an image of an animal, a repeating pattern beyond stripes, an image of sporting equipment, certain symbols, and/or the like.

### DEFINITIONS

Unless otherwise defined herein or below in the remainder of the specification, all technical and scientific terms used herein have meanings commonly understood by those of ordinary skill in the art to which the present invention belongs.

Before describing the present invention in detail, it is to be understood that this invention is not limited to particular devices or cooking methods, which can, of course, vary. It is also to be understood that the terminology used herein is for the purpose of describing particular embodiments only, and is not intended to be limiting. As used in this specification and the appended claims, the singular forms “a”, “an” and “the” can include plural referents unless the content clearly dictates otherwise. Thus, for example, reference to “a component” can include a combination of two or more components; reference to “food” can include mixtures of food, and the like.

Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

As used herein, the term “cooked” refers to food that is heated throughout and more than merely seared on part of the surface with one or more grill marks. The time and temperature of cooking, and extent of denaturation or browning required for food to be considered “cooked” can vary depending on the food and preferences of the chief. However, for purposes of distinguishing and clarifying the invention, food is not considered cooked on a grill if the center of the food does not reach at least 40° C., and the center has not raised in temperature by at least 5° C. during the period of grill contact while searing a mark on the food; food can be considered cooked when these temperature parameters are reached. With regard to meat, such as beef, lamb and chicken, “cooking” requires that the meat not be raw on the surface and the overall piece of meat is heated at least enough to be considered “rare” as is well known in the art. For example, beef can be considered cooked to the “rare” state when the internal temperature has reached at least 45° C., lamb at least 60° C., pork at least 70° C., and poultry at least 75° C.

As used herein, the term “sear” refers to contacting the surface of food with a hot surface so that a darkening or browning coloration results at points of contact of the food with the hot surface. The searing discoloration can result from chemical reactions in the food caused by the heat, such as, e.g., burning, caramelization, and/or the Maillard reaction.

As used herein, the term “wire” refers to a thread or rod of metal.

As used herein, the term “grill” refers to a food cooking grill with a perforated cooking surface, as is known in the art. Pots, pans, cooking surfaces without perforations, livestock type brands, and appliqués removably mounted to grills are not considered grills of the invention.

As used herein, the term “non-linear design” refers to a design consisting of more than a straight line or repeated series of straight lines. For example, a series of parallel line features or series of line features intersecting at a right angle are design elements considered linear. For example, a typical barbeque grill of parallel metal rods is not considered to have a non-linear design, and a typical screen of crossing wires is not considered to have a non-linear design; such grill surfaces do not sear non-linear marks into food, according to the concept of the invention.

As used herein, the term “two dimensional repeating matrix”, refers to a pattern of one or more design components that repeat in two non-parallel directions across the plane of a grill.

As used herein, the term “perforation” refers to a hole of any shape that runs all the way through a structure from one side to another. This is not merely a groove, texture or divot on one side of the structure.

As used herein, the term “symbol” refers to a mark that stands for or suggests something else. For example, the image of an eagle can be a symbol representing strength.

A “design component”, as used herein, refers to a component of a grill cooking surface that sears a design (or design outline) onto food at points of contact.

### BRIEF DESCRIPTION OF THE DRAWINGS

FIG. 1 shows a schematic diagram of a barbeque cooking device of the invention with a rectangular matrixed design on the cooking surface.

FIG. 2 shows representative cooking surfaces with indicia.

FIG. 3 shows a schematic diagram of an exemplary device including a grill fabricated from steel plate.

### DETAILED DESCRIPTION

The present invention concerns methods and devices to cook food while searing desired marks in the food. In general, the invention relates to cooking food on grills designed with mirror image designs present on a perforated cooking surface. The symbols can be present in the perforations and/or in the solid structure of the cooking surface. Devices of the invention typically include a heat source that transfers heat to the grill to sear and cook the food.

In a preferred embodiment, a device 10 for marking and cooking food 11 can be a barbeque grill 12 fabricated with mirror image design components 13 on the cooking surface 14. The grill is mounted, with the design components facing up, over a barbeque pit so that heat is transferred from a propane flame heat source 15 to the cooking surface. Each square on the cooking surface represents here a design element perforated through the cooking surface of the grill (such as the design elements of the following Figures) and not merely the standard linear pattern of an old art grill. Food of choice is placed upon the grill cooking surface in contact with design components where it can be both cooked and seared with, e.g., the desired non-linear mark at each position of contact with design components 13.

Unique and preferred embodiments include various aspects that will be described herein. For example, in certain embodiments, the entire grill, cooking surface, or design components lack a wire structure, e.g., being fabricated with perforations cut or stamped from unitary sheet metal stock. In other cases, neither the food nor the grill is in motion during the searing process. In other aspects of the invention, the mark searing takes place over an extended period of time, e.g., during the full cooking period or over a period of about 10 minutes or more. In many embodiments, the food is cooked and seared on one side while on top of the grill. In a favored embodiment, the design is repeated on the grill in a two-dimensional matrixed pattern.

### Grills

Grills of the invention are typically roughly planar perforated sheets of metal with the perforations on a cooking surface (i.e., design components) describing a mirror image of a desired design. The grills are usually made from a material, such as a metal, that can readily receive and conduct heat to the food.

The grills of the invention are different from typical standard cooking grills. Webster's defines grill as: “a cooking utensil of parallel bars on which food is exposed to heat”. These old grills can sear parallel grill marks (a linear design) onto the food. This type of grill cooking surface is not considered to provide a mirror image letter component or nonlinear design component. This type of grills, in itself is expressly not considered a perforated grill of the present invention. Grill marks on food from such a cooking surface are not considered sear marks from contact with a letter or non-linear design component. It is understood that standard grills can incidentally create linear designs that may be considered to approximate a letter “I” or “v”, etc.; or to incidentally result in square or striped sear mark designs, etc. These old standard grill surfaces and patterns that are incidental to cooking on standard grill surfaces expressly excluded from the present invention. Grills of the present invention can comprise such surfaces, but must include a cooking surface having a mirror image alphanumeric character design component and/or a non-linear design component, e.g., intended to convey information, such as symbolic information.

In many embodiments, the device of the invention can comprise aspects of a standard barbeque cooker, but with the standard wire/rod grill replaced with a compatibly configured grill having the unique cooking surfaces of the invention. For example, grills of the invention can include a grill of the proper shape and dimensions to be mounted in place of a standard grill (grate) in a particular barbeque (e.g., WEBER SMOKEY JOE). Optionally, the grill of the invention can be a standard grill modified to include a cooking surface with one or more incorporated mirror image letter or non-linear design components.

Grills of the invention can have any shape and size suitable for cooking and searing any particular food, or to be well adapted to mount in a particular barbeque cooker. Grills of the invention, as with standard grills, are typically relatively thin, generally planar structures. The grills can have any overall shape, such as, e.g., round, square, rectangular, polygonal, triangular, donut, kidney, star, etc. The grills can have a thickness, through the plane of the cooking surface, ranging from more than about 3 inches to less than about 0.01 inches, from about 1 inch to about 0.1 inches, from about 0.5 inches to about 0.15 inches, or about 0.25 inches. The grills can have a length or width ranging, e.g., from more than about 10 feet to about 1 inch, from about 5 feet to about 6 inches, from about 3 feet to about 1 foot, or about 2 feet.

In many embodiments, the grill can include wire components, e.g., a rod wire frame around the grill periphery or wire grate portion of the cooking surface. In a preferred embodiment, the entire grill, or at least the cooking surface or at least the part of the cooking surface having letter or design components, does not include any wire components. Because typical wire structures are cylindrical, grill marks from contact with the side of the wire can be indiscrete, due to the lack of an abrupt edge. Grills made, e.g., from perforated sheets of plates can have an advantage in forming sharper seared grill mark images on food. For example, the entire grill, the cooking surface, or at least the design components, can be a planar sheet of steel with perforations creating a design (or design outline).

Grills can be made from any material suitable for supporting food while cooking and searing. The grill material should be able to tolerate and transfer heat at temperatures ranging from about 100° C. to about 1000° C., from about 200° C. to about 500° C., or about 300° C. Grills can optionally be made from two or more different materials. Preferred materials for grills and cooking surfaces include metals, such as, e.g., iron, steel, titanium, stainless steel, chromium plated steel, nickel plated steel, and the like. Optionally, the grill can be formed from other materials, such as, graphite, brick, ceramics, etc.

### Indicia

The cooking surface of grills in methods and devices of the present invention can sear food so that indicia, such as letters or designs, are formed and visible on the food. The cooking surface is perforated so that contact with the food is not continuous. At points of contact, the grill cooking surface can sear the food causing a visible darkening or browning (sear marks). In methods and devices of the invention, the sear marks are visible, e.g., as indicia and/or outlines of indicia.

There is no intent, here, to patent any particular printed matter. What's more, the solid structural and functional relationships between the indicia and the grills and/or food involved in the methods and devices of this invention provide patentable subject matter (see, In re Miller, 418 F.2d1392, 164 USPQ 46, 1969). For example, the indicia (design component searing surfaces) support the food, modify the food, and transfer information onto the food in a unique way.

Grills of the invention have cooking surfaces with design components that can leave sear marks suggesting alphanumeric characters. For example, the sear marks can be numbers or letters of the English alphabet. Because the sear marks are essentially mirror images of the cooking surface, a cooking surface to sear letters onto food must present a mirror image of the letters. In the case of many alphanumeric characters, depending, e.g., on the font, the character is the same as its mirror image (for example, the block letters A, H, I, M, O, T, U, V, W, X, Y; block numbers 1, 8, and 0). Many alphanumeric characters are different from their mirror image and need to be presented as a mirror image (e.g., flipped 180 degrees about their vertical axis as seen presented on a vertical surface) on a cooking surface to transfer the correct character in searing contact with food. For example, the block letters B, C, D, E, F, G, J. K, L, N, P, Q, R, S, and Z, and the numbers 2, 3, 4, 5, 6, 7 and 9, should be presented as mirror image characters for searing food from a cooking surface. Of course, one skilled in the art will understand what characters from other alphabets or other writing systems (e.g., Chinese, cursive) should be presented as mirror images.

Because indicia include lines that come back on themselves, an unsupported center may be created in a pierced design. For example, the letter “O” would become a large circular hole if pierced from a surface. One solution to this problem is to use intermittent lines, such as, e.g., dotted or dashed lines to trace an image or letter. Optionally, isolated design searing surfaces can be supported from behind the surface, e.g., by recessed bridges to adjacent grill structures, e.g., while retaining substantial perforated character through the surface.

In another aspect, the indicia presented by perforation of a grill cooking surface for searing food can be non-linear design components. As described above in the Grills section, the parallel lines seared in food by standard barbeque grills are considered linear grill marks and not non-linear designs. For example, a non-linear design component on a grill can have curving lines, perforated points, and/or substantial planar areas. Not counting repetitions of the same design on a cooking surface, a non-linear design can comprise one or more, two or more, 5 or more, 100 or more curved lines. The design can include linear aspects, but also comprise non-linear design components. Typical non-linear design components of grill cooking surfaces include, e.g., many trademarks, logos, image outlines, line drawings, symbols, logos, and/or the like.

In yet another aspect, the indicia presented by perforation of a grill cooking surface for searing food can be non-repetitive non-linear design elements. Although some embodiments of the invention include, e.g., designs repeated in 2-dimensional matrixed (e.g., columns and rows, or radially expanding) patterns, other embodiments include only a single iteration of a design on the cooking surface. For example, a grill can include a single mirror image representation of an anagram, trademark or line image. Usually, such a design is relatively large, takes up a large portion of the cooking surface, or is on a scale appropriate to the food of choice so it is legible once seared onto the food.

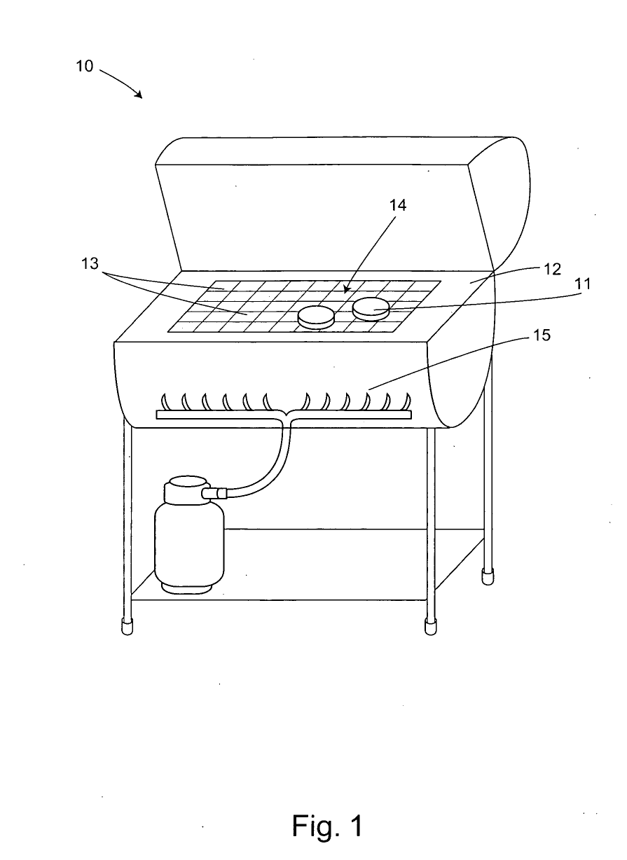

Design components can take up any portion of the grill cooking surface. In some embodiments, the design components cover the entire upper grill surface from edge to edge. In other embodiments, the design components cover the cooking surface which is peripherally bordered with an unpatterned rim (such as the grill shown in FIG. 1). In other embodiments, the grill has a significant area of non-design cooking surface. The portion of the grill cooking surface covered with design components (including both the searing surfaces and perforation voids) can range from about 100 percent to about 1 percent, from about 90 percent to about 10 percent, from about 75 percent to about 25 percent, or about 50 percent.

In some embodiments, the indicia are arranged in a repetitive pattern on the cooking surface. For example, a certain combination of letters can be repeated in a matrix pattern of perpendicular or diagonally aligned rows and columns. In practice, the repeated indicia searing surfaces often overlap to a certain extent to provide mutual structural support. Indicia can optionally be repeated in other arrangements, such as radial, random or spiraling patterns.

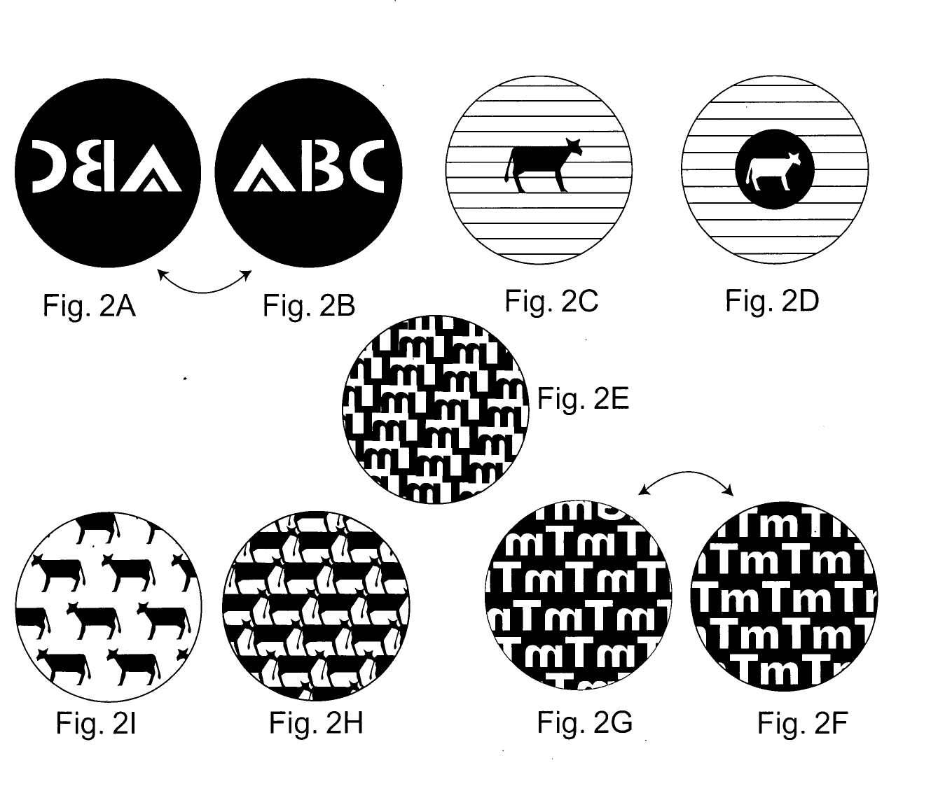

Representative indicia that can be used on searing cooking surfaces of the invention are shown in FIG. 2. An example of alphanumeric indicia is shown in FIG. 2A wherein mirror image alphanumeric character components (stylized “ABC” characters) are presented outlined on the cooking surface side of the grill; the characters can be read substantially as they will appear outlined in sear marks, as shown in grill back side FIG. 2B. As shown here for example, the character style (font) can be selected to employ letters that provide structural support to surfaces that represent voids in letters. FIG. 2C shows how a searing surface image, e.g., a cow silhouette in sheet metal, can be presented incorporated upon a standard wire barbeque grill. FIG. 2D shows how an image outline-searing surface can be incorporated onto a standard wire grill. In FIG. 2E, shows how a searing surface of a two dimensional matrix of mirror image alphanumeric character components can be presented on a grill. Pierced regions (holes) in the surface are represented in white; grill (e.g., searing) surfaces in black. Note that the mirror image letters “Tm” are in mutual contact to provide physical support across the searing surface (e.g., no letters are unconnected to the grill as a whole). In an optional embodiment, the mirror image letters are represented outlined by searing surfaces, as shown in FIG. 2F. Note that each pierced letter is surrounded by cooking-searing surfaces. FIG. 2G is a representation of the grill back side presenting essentially the outlined letters as they would be seared onto food. In a similar fashion, non-linear design components (cows) can be presented in a two dimensional matrix, e.g., with mutually contacting cow searing surfaces (as shown in FIG. 2H), and/or separate pierced cow outlines (as shown in FIG. 2I) through the grill.

### Heat Sources

Heat sources are employed in methods and devices of the invention to sear and cook food placed in contact with the grills. Heat sources can transfer heat to the grills so they can sear the food. The food can be cooked by contact with the grill and/or by heat transferred directly from the heat source. In many embodiments, the grill searing heat source in the same heat source that provides heat to cook the food.

Heat sources used in devices and methods of the invention can be any with the capacity and temperature levels required to sear and cook a particular food on a particular grill. Typical heat sources include, e.g., charcoal briquettes, burning wood, burning coal, a propane flame, butane flame, natural gas flame, white gas flame, a solar reflector, an electric resistive heating element, a hot fluid, infrared lamps, and the like.

In the devices for cooking and marking food, it is preferred that the heat source be located in or below the grill. In some embodiments, the heat source is inside the grill or in direct contact with the grill. For example, resistive heat elements or hot fluids can be incorporated into the grill so the food is cooked and seared by heat directly from the grill. In more common applications, the heat source is located below the grill and convection of heated air or combustion gases transfers heat to the grill and the food.

The heat source should be capable of transferring heat to the grill and/or food so that adequate temperatures are attained for cooking and searing. Depending, e.g., on the type of heat source, it can have a temperature ranging from about 2000° C. to about 100° C., from about 1500° C. to about 250° C., or from about 1000° C. to about 500° C.

### Food

The devices and methods can cook and sear marks onto food. Such food is typically a type of food that requires cooking or benefits from cooking. Food most suitable to receive seared marks has a surface capable of close contact with the grill cooking surfaces. Suitable foods are generally required to have enough structural integrity before cooking not to fall through the perforations of the grill.

Food for sear marking is usually meat or vegetables. These foods often present a good surface for searing and receive benefits from cooking. Typical meat for searing includes, e.g., hamburger patties, beef steaks, roasts, hot dogs, fish filets, chicken parts, etc. Typical vegetables for searing marks onto include, e.g., potatoes, mushrooms, corn on the cob, peppers, squash, and the like. Other foods can be suitable for searing and cooking on the grills, such as cheeses and breads.

### Methods of Indicia Searing

Indicia can be seared onto food using methods of the invention. Typically, a grill with a perforated cooking surface having mirror image indicia is heated by a heat source. Food is placed on the cooking surface where it is cooked and receives a sear mark in the form of the desired indicia.

The grills can be manufactured from appropriate materials by forging, casting, rolling and cutting, appliqué and the like. The grills are perforated clear through, at least at the cooking surface and particularly at the contact area of the design component. In this way, the design component can be considered a unitary part of the grill. Because the grills are perforated through, there are structural design considerations, e.g., to provide support for the surface and food. For example, in embodiments where a design is repeated in a matrix, the designs can contact each other for mutual support. Where the design is outlined by searing contact with the cooking surface, design outlines can contact each other for mutual structural support. In some cases, aspects of design outlines and positive designs can contact for mutual support. Where it is necessary or desirable that searing surfaces not be in contact with certain other searing surfaces (e.g., where matrixed designs must be separate from each other or in designs with certain features that should be separate from others), recessed structural members can be used. For example, isolated searing surfaces can be connected to other searing surfaces in a design through “U” shaped wire bridges behind the searing surfaces. In preferred embodiments, design components are connected at the cooking surface and not through recessed structures.

In preferred embodiments, the edge between a searing surface of a design component and a perforation void is abrupt. That is, the edge does not gradually slope down away from the cooking surface. This can provide high resolution in seared grill marks. In preferred embodiments, the edge is “square” with the edge surface perpendicular to the searing surface, or has an angular cross section.

Food is seared by contact with the heated grills. In a preferred embodiment, the grill is preheated to a searing temperature before the food makes contact with the design on the cooking surface. For example, a propane flame below the grill can be turned on several minutes before placing the food on the grill so that high temperatures can be reached on the cooking surface. The heat energy stored on the grill surface can be quickly released at the food surface on contact to sear an image. Overall cooking can follow with the gradual transfer of heat from the flame to the food. Optionally, the grill and food can be heated together, e.g., with searing resulting at the grill cooking surfaces due to rapid conduction of heat to the food by the grill as compared to the transfer of heat from hot gasses from the propane flame.

In preferred embodiments, the food is placed on top of the grill. This can be convenient for the use of typical cooking tools, such as spatulas. Top food placement can be efficient because heat from the heat source and grill can be transferred up by hot gasses to contact the food. The perforations in the grill surface can allow drippings to be released, e.g., to enhance conditions for grill marking. Optionally, the heat source and/or grill can be located above the food during cooking and/or searing.

In many embodiments of the invention, neither the food nor the grill is in motion during cooking or searing operations. In some embodiments, the grill and food move together, e.g., over a heat source, but do mot move relative to each other.

### EXAMPLES

The following examples are offered to illustrate, but not to limit the claimed invention.

### Example 1

### Back Yard Bar-B-Que

A round covered barbeque set was prepared with a grill having a matrixed pattern of interconnected letter searing surfaces (e.g., a corporate logo).

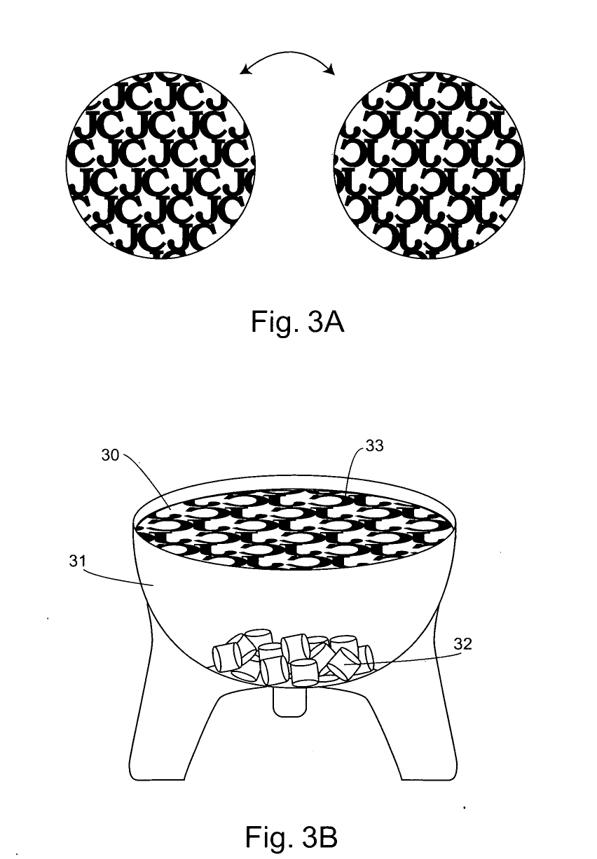

A grill was prepared to replace the standard grill in a commonly available back yard barbeque cooker. The grill, as shown in FIG. 3A, was prepared by perforation of ¼-inch thick steel plate stock using a pantograph controlled cutting torch. A computer generated two-dimensional matrixed design was prepared and printed in black and white on paper at 1:1 scale. The paper image was placed on the “originals” table of the cutter and the blank steel plate was placed under the cutting torch. A photo-sensitive eye over the originals table shared a carriage with the cutting torch. Information on the location of original image edges was fed to a computer that controlled motors to move the carriage in an X-Y plotting motion. As the photo-eye was tracked along the original image edges, the cutting torch followed a similar path over the steel plate while cutting perforations corresponding to the image edges. When all the image edges had been tracked, a duplicate of the original image remained in the perforated steel plate.

The final product was a 13.5-inch round grill that fit the mounting brackets to replace the standard grill in a SMOKEY JOE WEBER barbeque cooker. The back side of the cut steel plate was a mirror image of the original image pattern. The grill 30 was mounted in the cooker 31 over burning barbeque charcoal briquettes 32 with the grill back side (mirror image) facing up as the cooking and searing surface 33. Hamburger patties were place on top of the grill on the design components of the cooking surface. The patties were immediately seared with a replica of the original image. The patties were eventually turned with a spatula to sear the other side. After about 10 minutes, the patties were cooked and seared on both sides. The original image was readily visible as sear marks on the surface of the cooked patties.

It is understood that the examples and embodiments described herein are for illustrative purposes only and that various modifications or changes in light thereof will be suggested to persons skilled in the art and are to be included within the spirit and purview of this application and scope of the appended claims.

While the foregoing invention has been described in some detail for purposes of clarity and understanding, it will be clear to one skilled in the art from a reading of this disclosure that various changes in form and detail can be made without departing from the true scope of the invention. For example, many of the techniques and apparatus described above can be used in various combinations.

All publications, patents, patent applications, and/or other documents cited in this application are incorporated by reference in their entirety for all purposes to the same extent as if each individual publication, patent, patent application, and/or other document were individually indicated to be incorporated by reference for all purposes.

What is claimed is:

1. A device for cooking and marking food, the device comprising:
a grill comprising a perforated cooking surface, the surface comprising one or more mirror image alphanumeric character components or nonlinear design components; and,
a heat source functionally positioned to transfer heat to the grill;
whereby food placed on the grill is cooked and receives a sear mark from contact with the character or design component.

2. The device of claim 1, wherein the grill comprises a material selected from the group consisting of: a metal, stainless steel, chromed steel, and ceramic.

3. The device of claim 1, wherein the character components or design components comprise an angular edge.

4. The device of claim 1, wherein the character or design components are not removably mounted.

5. The device of claim 1, wherein the character or design components comprise cooking surfaces in substantially the same plane as the cooking surface generally.

6. The device of claim 1, wherein the grill is stationary during contact with the food.

7. The device of claim 1, wherein the cooking surface, character components or design components are substantially free of wires.

8. The device of claim 1, wherein the heat source is selected from the group consisting of: burning charcoal, propane flame, solar heat, hot fluids, a natural gas flame, electrical resistive heating elements, and a wood fire.

9. The device of claim 1, wherein the heat source is positioned below the grill.

10. The device of claim 1, wherein the food is selected from the group consisting of: meat, hamburger patties, veggie burgers, vegetables, hot dogs, and fish.

11. The device of claim 1, wherein the sear mark is selected from the group consisting of: a logo, a trade mark, an acronym, two or more different alphanumeric characters, initials of a person, an image of an animal, a repeating pattern, and sporting equipment.

12. A device for marking food, the device comprising:
a grill substantially formed from a sheet of heat resistant material and comprising a perforated cooking surface, the cooking surface comprising one or more mirror image alphanumeric character or nonlinear design components; and,
a heat source functionally positioned to transfer heat to the grill;
whereby food placed on the grill receives a sear mark from contact with the character or design component.

13. The device of claim 12, wherein the grill comprises a material selected from the group consisting of: a metal, stainless steel, chromed steel, and ceramic.

14. The device of claim 12, wherein character components or design components comprise an angular edge.

15. The device of claim 12, wherein the grill is stationary during contact with the food.

16. The device of claim 12, wherein the cooking surface, character components or design components are substantially free of wires.

17. The device of claim 12, wherein the character or design components comprise cooking surfaces in substantially the same plane as the cooking surface generally.

18. The device of claim 12, wherein the heat source is selected from the group consisting of: burning charcoal, propane flame, solar heat, a hot fluid, a natural gas flame, electrical resistive heating elements, and a wood fire.

19. The device of claim 12, wherein the heat source is positioned below the grill.

20. The device of claim 12, wherein the food is selected from the group consisting of: meat, hamburger patties, veggie burgers, vegetables, hot dogs, and fish.

21. The device of claim 12, wherein the sear mark is selected from the group consisting of: a logo, a trade mark, an acronym, two or more different alphanumeric characters, initials of a person, an image of an animal, a repeating pattern, and sporting equipment.

22. A device for marking food, the device comprising:
a stationary grill comprising a perforated cooking surface, the cooking surface comprising one or more mirror image alphanumeric characters or nonlinear design components; and,
a heat source functionally positioned to transfer heat to the grill;
whereby food placed on the grill receives a sear mark from contact with the character or design component.

23. The device of claim 22, wherein the grill comprises a material selected from the group consisting of: a metal, stainless steel, chromed steel, and ceramic.

24. The device of claim 22, wherein character components or design components comprise an angular edge.

25. The device of claim 22, wherein the cooking surface, character components or design components are substantially free of wires, or wherein the character or design components comprise cooking surfaces in substantially the same plane as the grill cooking surface generally.

26. The device of claim 22, wherein the heat source is selected from the group consisting of: burning charcoal, propane flame, solar heat, a hot fluid, a natural gas flame, electrical resistive heating elements, and a wood fire.

27. The device of claim 22, wherein the heat source is positioned below the grill.

28. The device of claim 22, wherein the food is selected from the group consisting of: meat, hamburger patties, veggie burgers, vegetables, hot dogs, and fish.

29. The device of claim 22, wherein the sear mark is selected from the group consisting of: a logo, a trade mark, an acronym, two or more different alphanumeric characters, initials of a person, an image of an animal, a repeating pattern, and sporting equipment.

30. A device for marking food, the device comprising:
a grill comprising a perforated cooking surface, the cooking surface comprising one or more mirror image alphanumeric character components or nonlinear design components, the components being arranged in a pattern repeating in two dimensional repeating matrix; and,
a heat source functionally positioned to transfer heat to the grill;
whereby food placed on the grill receives a sear mark from contact with the character or design components.

31. The device of claim 30, wherein the grill comprises a material selected from the group consisting of: a metal, stainless steel, chromed steel, and ceramic.

32. The device of claim 30, wherein character components or design components comprise an angular edge.

33. The device of claim 30, wherein the grill is stationary during contact with the food.

34. The device of claim 30, wherein the cooking surface, character components or design components are substantially free of wires.

35. The device of claim 30, wherein the heat source is selected from the group consisting of: burning charcoal, propane flame, solar heat, a hot fluid, a natural gas flame, electrical resistive heating elements, and a wood fire.

36. The device of claim 30, wherein the heat source is positioned below the grill.

37. The device of claim 30, wherein the food is selected from the group consisting of: meat, hamburger patties, veggie burgers, vegetables, hot dogs, and fish.

38. The device of claim 30, wherein the sear mark is selected from the group consisting of: a logo, a trade mark, an acronym, two or more different alphanumeric characters, initials of a person, an image of an animal, and sporting equipment.

39. A method of cooking and marking food, the method comprising:
heating a grill comprising a perforated cooking surface, the surface comprising one or more mirror image alphanumeric character or nonlinear design components, or outlines thereof; and,
placing food on top of the grill;
whereby the food is cooked and receives a sear mark from contact with the character or design component, or outline thereof.

40. The method of claim 39, wherein said heating is from a heat source below the grill.

41. The method of claim 39, wherein the grill cooking surface is substantially free of wires or comprises a perforated sheet of material.

42. The method of claim 39, wherein the grill and food are not moving during the searing contact.

43. The method of claim 39, wherein said cooking comprises heating the food to 130° F. or more.

44. The method of claim 39, wherein said cooking comprises heating the food for 5 minutes or more.

45. The method of claim 39, wherein the food is selected from the group consisting of: meat, hamburger patties, veggie burgers, vegetables, hot dogs, and fish.

46. The method of claim 39, wherein the sear mark is selected from the group consisting of: a logo, a trade mark, an acronym, two or more different alphanumeric characters, initials of a person, an image of an animal, and sporting equipment.

47. The food seared and cooked by the method of claim 39.

48. A device for cooking and marking food, the device comprising:
a grill comprising a perforated cooking surface, the perforations comprising one or more mirror image alphanumeric character components or nonlinear design components; and,
a heat source functionally positioned to transfer heat to the grill;
wherein food placed on the grill is cooked and receives a sear mark from contact with the cooking surface, thus outlining the character or design component on the surface of the food.

49. A device for cooking and marking food, the device comprising:
a grill comprising a substantially horizontal perforated metal plate cooking surface, the surface or perforations comprising one or more mirror image alphanumeric character components or nonlinear design components;
the food comprising meat or vegetables and resting on top of the cooking surface character or design components; and,
a charcoal or propane heat source beneath the grill and functionally positioned to transfer heat to the grill;
wherein the food is cooked and receives a sear mark from contact with the cooking surface, thus grill marking or outlining the character or design component on the surface of the food.
